(19) United States
(12) Patent Application Publication
(10) Pub. No.: US 2008/0068789 A1
(43) Pub. Date: Mar. 20, 2008

(54) Coupling For A Modular Component And Chassis Combination

(75) Inventors: Darren B. Pav, Round Rock, TX (US); Tifenn Boisard, Austin, TX (US)

Correspondence Address: HAYNES AND BOONE, LLP, 901 Main Street, Suite 3100, Dallas, TX, 75202, US

(73) Assignee: Dell Products L.P., Round Rock, TX (US)

(21) Appl. No.: 11/531,942

(22) Filed: Sep. 14, 2006

(51) Int. Cl. G06F 1/20

(52) U.S. Cl. 361/687

(57) ABSTRACT

A modular component coupling apparatus includes a chassis defining a chassis housing. A modular component mounting member is pivotally coupled to the chassis, wherein the modular component mounting member defines a modular component housing, whereby the modular component mounting member is operable to pivot relative to the chassis between a first position that is outside of the chassis housing and a second position that is within the chassis housing.

### BACKGROUND

The present disclosure relates generally to information handling systems, and more particularly to coupling a modular component to an information handling system chassis.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

As the performance of IHSs is increased, the size and density of the components used in the IHS chassis that houses the IHS increases as well. This can raise a number of issues related to thermal cooling, support, mounting locations, and retention of the different components of the IHS in the IHS chassis.

The IHS chassis size may be dictated by the need for the IHS chassis to fit in standard enclosure such as, for example, a server rack. It may be desirable to continue to use a particular size IHS chassis even as the performance of the IHS increases and the space availability in the IHS chassis decreases. For example, a chassis housing the Balanced Technology Extended (BTX) form factor motherboards allows for the mounting of the hard drives adjacent the BTX form factor motherboard. However, when the Server System Infrastructure (SSI) form factor motherboard is used in the same chassis, the space available in the chassis for the hard drives when using the BTX form factor motherboard is no longer available. It is desirable to continue to use the same chassis, but repositioning the hard drives in the chassis raises issues such as, for example, the cooling of the memory cards, the support of the processor heat sinks, the retention of the expansion cards, and the desire to not compromise the serviceability of the IHS.

Accordingly, it would be desirable to provide for coupling a modular component to a chassis absent the disadvantages discussed above.

### SUMMARY

According to one embodiment, a modular component coupling apparatus includes a chassis defining a chassis housing, and a modular component mounting member pivotally coupled to the chassis, wherein the modular component mounting member defines a modular component housing, whereby the modular component mounting member is operable to pivot relative to the chassis between a first position that is outside of the chassis housing and a second position that is within the chassis housing.

### BRIEF DESCRIPTION OF THE DRAWINGS

FIG. 1 is a schematic view illustrating an embodiment of an IHS.

FIG. 2a is a perspective view illustrating an embodiment of a modular component mounting member.

FIG. 2b is a perspective view illustrating an embodiment of the modular component mounting member of FIG. 2a.

FIG. 3 is a perspective view illustrating an embodiment of a card retention member used with the modular component mounting member of FIGS. 2a and 2b.

FIG. 4 is a perspective view illustrating an embodiment of a fan module used with the modular component mounting member of FIGS. 2a and 2b.

FIG. 5 is a perspective view illustrating an embodiment of a modular component used with the modular component mounting member of FIGS. 2a and 2b.

FIG. 6 is a perspective view illustrating an embodiment of a chassis used with the modular component mounting member of FIGS. 2a and 2b.

FIG. 7a is a flow chart illustrating an embodiment of a method for coupling a modular component to a chassis.

FIG. 7b is a perspective view illustrating an embodiment of the card retention member of FIG. 3 coupled to the modular component mounting member of FIGS. 2a and 2b.

FIG. 7c is a perspective view illustrating an embodiment of the fan module of FIG. 4 coupled to the modular component mounting member of FIGS. 2a and 2b.

FIG. 7d is a perspective view illustrating an embodiment of the modular component mounting member of FIGS. 7b and 7c coupled to the chassis of FIG. 6.

FIG. 7e is a perspective view illustrating an embodiment of the modular component of FIG. 5 coupled to the modular component mounting member of FIGS. 7b and 7c.

FIG. 7f is a perspective view illustrating an embodiment of a plurality of cables routed on the modular component mounting member of FIG. 7e.

FIG. 7g is a perspective view illustrating an embodiment of the modular component mounting member of FIG. 7d pivoted into a closed position.

FIG. 7h is a perspective view illustrating an embodiment of the modular component mounting member and chassis of FIG. 7g with a plurality of cards positioned in the chassis.

FIG. 7i is a perspective view illustrating an embodiment of the modular component mounting member and chassis of FIG. 7h with the card retention member pivoted into engagement with the cards.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

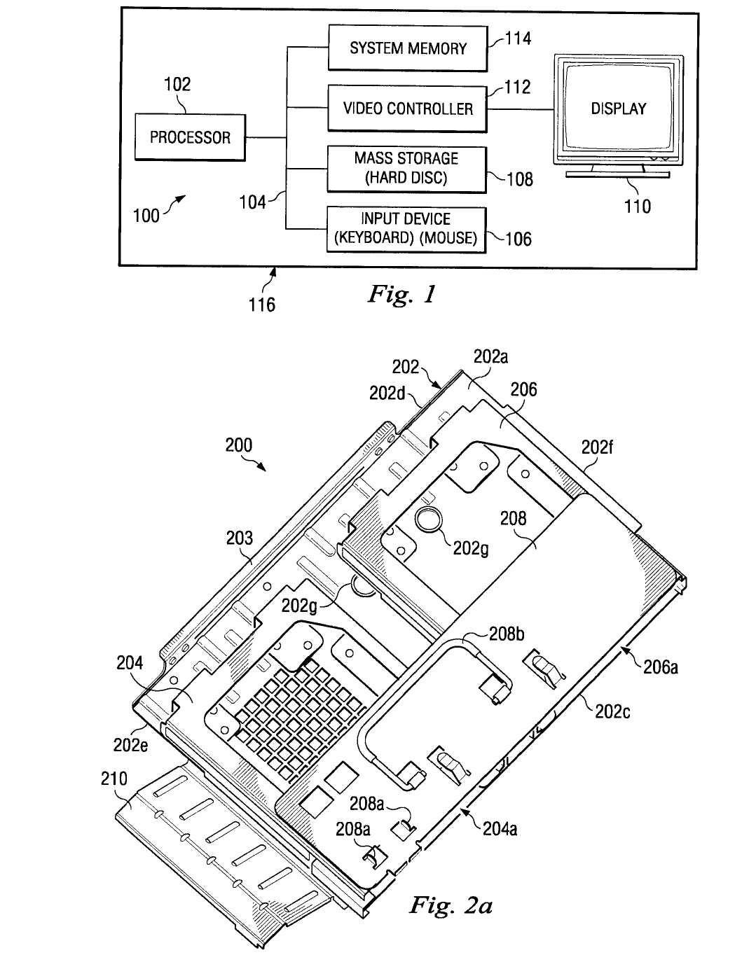

In one embodiment, IHS 100, FIG. 1, includes a processor 102, which is connected to a bus 104. Bus 104 serves as a connection between processor 102 and other components of computer system 100. An input device 106 is coupled to processor 102 to provide input to processor 102. Examples of input devices include keyboards, touchscreens, and pointing devices such as mouses, trackballs and trackpads. Programs and data are stored on a mass storage device 108, which is coupled to processor 102. Mass storage devices include such devices as hard disks, optical disks, magneto-optical drives, floppy drives and the like. IHS 100 further includes a display 110, which is coupled to processor 102 by a video controller 112. A system memory 114 is coupled to processor 102 to provide the processor with fast storage to facilitate execution of computer programs by processor 102. In an embodiment, a chassis 116 houses some or all of the components of IHS 100. It should be understood that other buses and intermediate circuits can be deployed between the components described above and processor 102 to facilitate interconnection between the components and the processor 102.

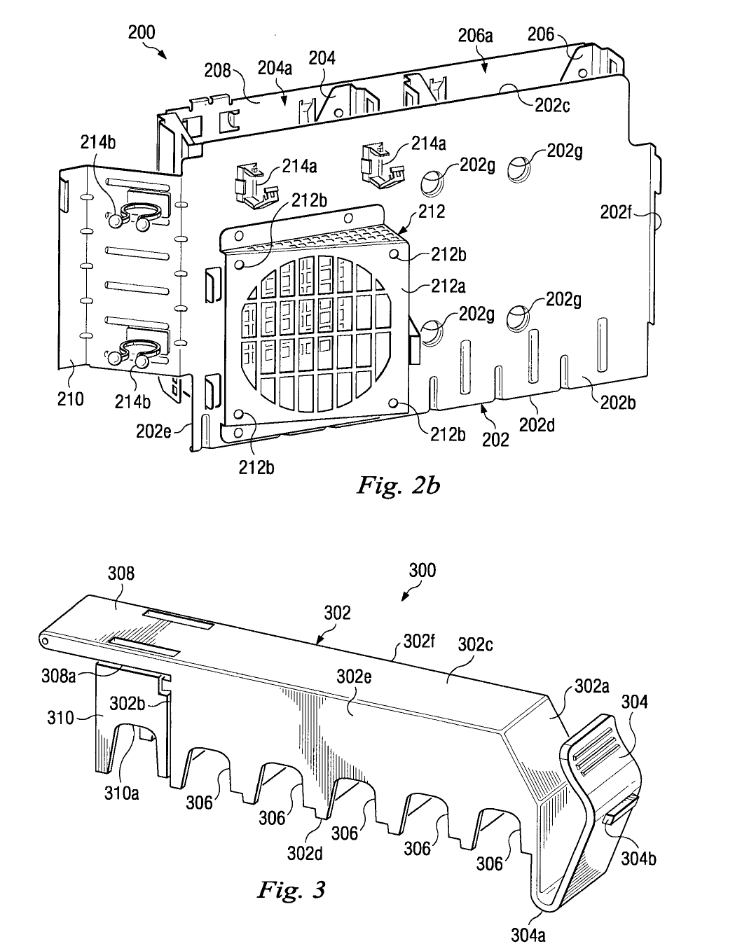

Referring now to FIGS. 2a and 2b, a modular component mounting member 200 is illustrated. The modular component mounting member 200 includes a base 202 having a top surface 202a, a bottom surface 202b located opposite the top surface 202a, a front edge 202c extending between the top surface 202a and the bottom surface 202b, a rear edge 202d located opposite the front edge 202c and extending between the top surface 202a and the bottom surface 202b, and a pair of opposing side edges 202e and 202f extending between the top surface 202a, the bottom surface 202b, the front edge 202c, and the rear edge 202d. The base 202 also defines a plurality of heat sink support features 202g located in a spaced apart relationship on the base 202 and extending through the base 202 from the bottom surface 202b to the top surface 202a. A pivotal coupling member 203 extends from the rear edge 202d of the base 202 and is oriented substantially perpendicularly to the top surface 202a of the base 202. A pair of modular component housing members 204 and 206 are coupled to the top surface 202a of the base 202, each modular component housing member 204 and 206 defining a modular component housing 204a and 206a, respectively. A handle support 208 is coupled to and extends between the modular component housing members 204 and 206 and includes a pivotal coupling feature 208a extending from a surface of the handle support 208 adjacent the front edge 202c of the base 202. A handle 208b is pivotally coupled to the handle support 208 and that pivotal coupling may be biased such that the handle 208b is biased towards a surface of the handle support 208 but may be pivoted away from that surface such that the handle 208b may be grasped. A baffle member 210 extends from the side edge 202e of the base 202 and is oriented at an angle with respect to the base 202. A fan mount 212 is coupled to the bottom surface 202b of the base 202 and includes a mounting surface 212a that is oriented at an angle with respect to the bottom surface 202b of the base 202. A plurality of fan mounting apertures 212b are defined by the fan mount 212 and located in a spaced apart relationship on the mounting surface 212a. A plurality of cable routing members 214a extend from the bottom surface 202b of the base 202 and are located between the fan mount 212 and the front edge 202c of the base 202. A plurality of cable routing members 214b also extend from the baffle member 210.

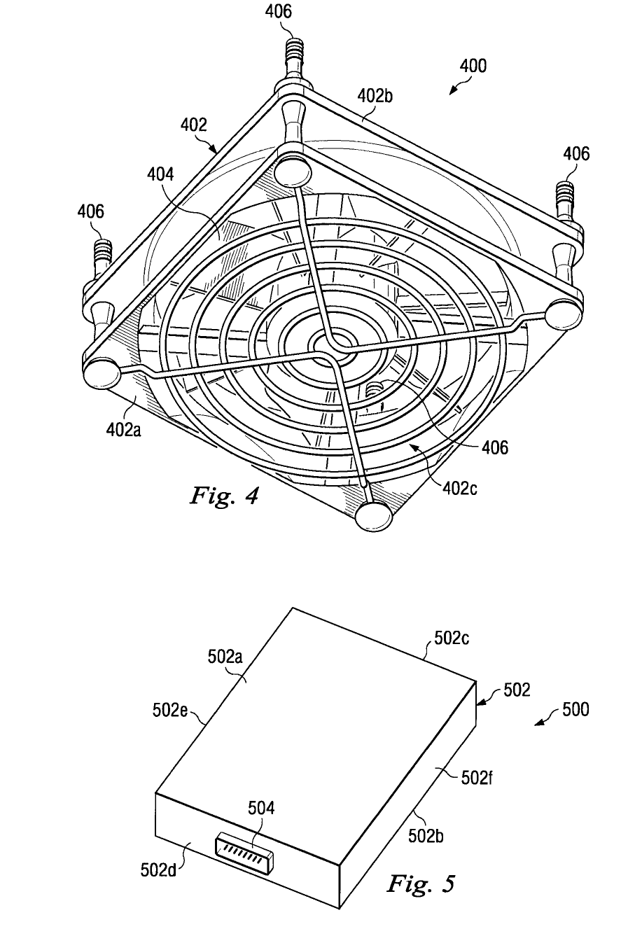

Referring now to FIG. 3, a card retention member 300 is illustrated. The card retention member 300 includes a base 302 having a front surface 302a, a rear surface 302b located opposite the front surface 302a, a top surface 302c extending between the front surface 302a and the rear surface 302b, a bottom surface 302d located opposite the top surface 302c and extending between the front surface 302a and the rear surface 302b, and a plurality of side surfaces 302e and 302f extending between the front surface 302a, the rear surface 302b, the top surface 302c, and the bottom surface 302d. A handle 304 extends from front surface 302a of the base 302 on a resilient coupling 304a that allows the handle 304 to move relative to the base 302. A securing member 304b extends from the handle 304 and away from the front surface 302a of the base 302. The base 302 defines a plurality of card engagement channels 306 located in a spaced apart orientation along the length of the base 302. A pivotal coupling member 308 extends from the rear surface 302b of the base 302 and defines an optional card engagement feature channel 308a between itself and the rear surface 302b of the base 302. An optional card engagement feature 310 defines a card engagement channel 310a and may couple to and decouple from the base 302 in the optional card engagement feature channel 308a.

Referring now to FIG. 4, a fan 400 is illustrated. The fan module 400 includes a base 402 having a front surface 402a, a rear surface 402b located opposite the front surface 402a, and defining a fan housing 402c located between the front surface 402a and the rear surface 402b. A fan 404 is coupled to the base 402 and located in the fan housing 402c. A plurality of couplers 406 extend from the rear surface 402b of the base 402 and in a spaced apart orientation at each corner of the base 402.

Referring now to FIG. 5, a modular component 500 is illustrated. In an embodiment, the modular component 500 may be, for example, a mass storage device such as the mass storage device 108 described above with reference to FIG. 1. In an embodiment, the modular component 500 is a hard drive. The modular component 500 includes a base 502 having a top surface 502a, a bottom surface 502b located opposite the top surface 502a, a front surface 502c extending between the top surface 502a and the bottom surface 502b, a rear surface 502d located opposite the front surface 502c and extending between the top surface 502a and the bottom surface 502b, and a pair of side surfaces 502e and 502f extending between the top surface 502a, the bottom surface 502b, the front surface 502c, and the rear surface 502d. An IHS connector 504 extends from the rear surface 502d and is located on the rear surface 502b adjacent the side surface 502f.

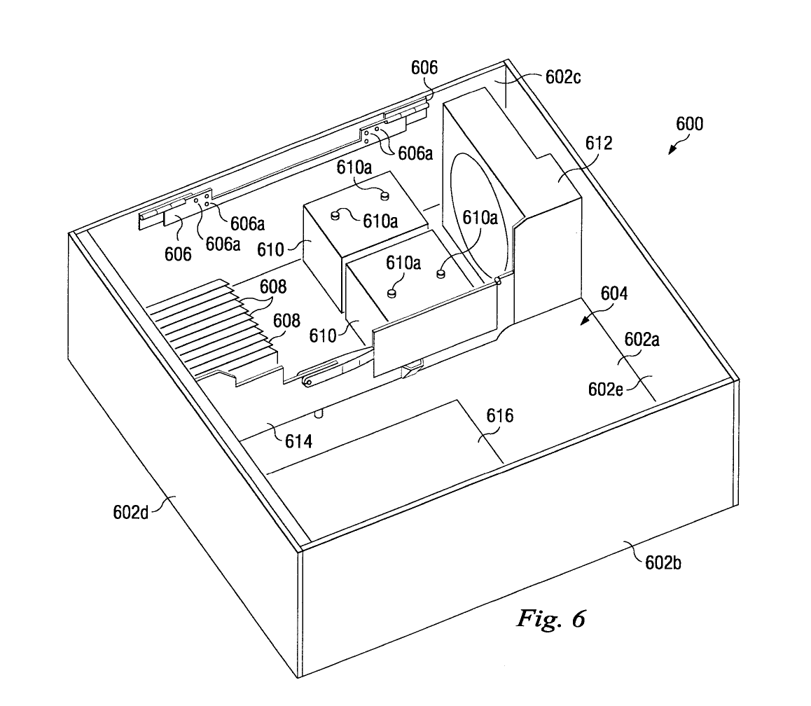

Referring now to FIG. 6, a chassis 600 is illustrated. In an embodiment, the chassis 600 may be, for example, the chassis 116, described above with reference to FIG. 1, and may house some or all of the components of the IHS 100, described above with reference to FIG. 1. The chassis 600 includes a chassis floor 602a which may include, for a example, a board such as, for example, an Server System Infrastructure (SSI) Form Factor motherboard. A front wall 602b extends from the chassis floor 602a. A rear wall 602c extends from the chassis floor 602a and is located opposite the front wall 602b in a spaced apart relationship from the front wall 602b. A pair of side walls 602d and 602e extend from the chassis floor 602a and between the front wall 602b and the rear wall 602c in a spaced apart relationship from each other. An IHS housing 604 is defined between the chassis floor 602a, the front wall 602b, the rear wall 602c, and the side walls 602d and 602e. A pivotal coupling 606 is located on the rear wall 602c, extends into the IHS housing 604, and defines a plurality of coupling apertures 606a located along its length. In an embodiment, the pivotal coupling 606 may include, for example, a friction hinge. A plurality of heat producing devices 608 which may be, for example, memory devices, are coupled to the chassis floor 602a and located in the IHS housing 604. A plurality of heat sinks 610 are coupled to the chassis floor 602a and located in the IHS housing 604, may be coupled to processors such as, for example, the processor 102, described above with reference to FIG. 1, and are located adjacent the heat producing devices 608. A plurality of heat sink support members 610a extend from the heat sinks 610 and, in embodiment, may include, for example, heat pipes. A fan 612 is coupled to the chassis floor 602a and located in the IHS housing 604 adjacent the heat sinks 610. A baffle 614 extends across the IHS housing 604 between the sides walls 602d and 602e and is located adjacent the heat producing devices 608, the heat sinks 610, and the fan 612. A support 616 is coupled to the chassis floor 602a and located in the IHS housing 604 adjacent the front wall 602b and the side wall 602d.

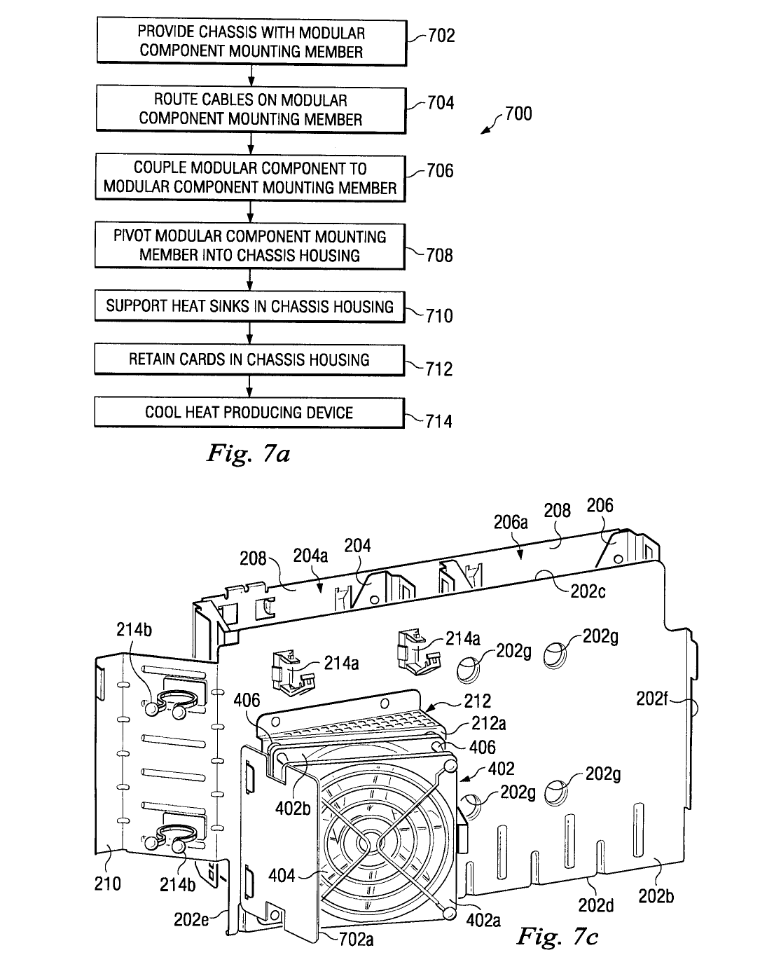

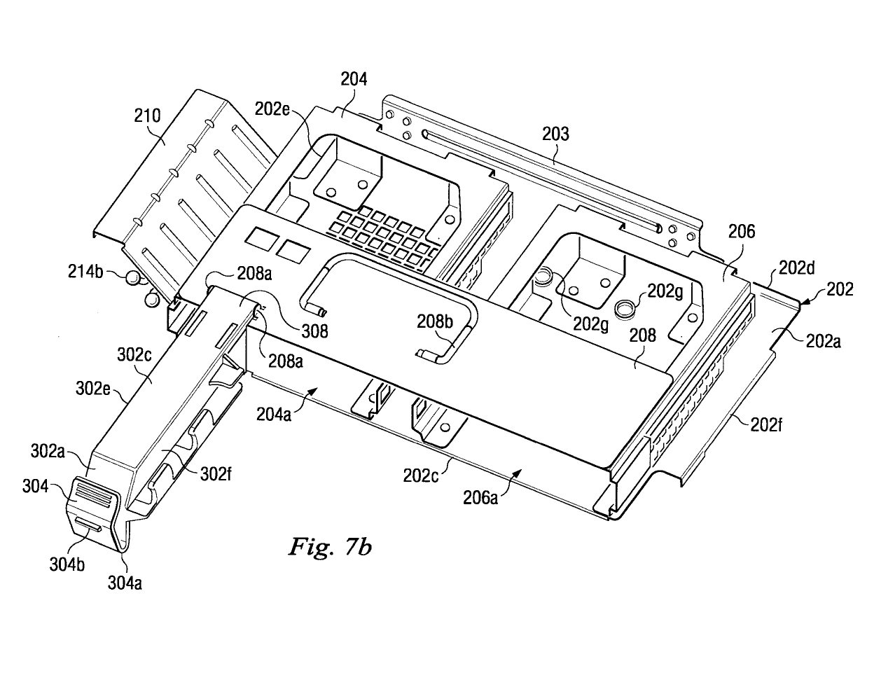

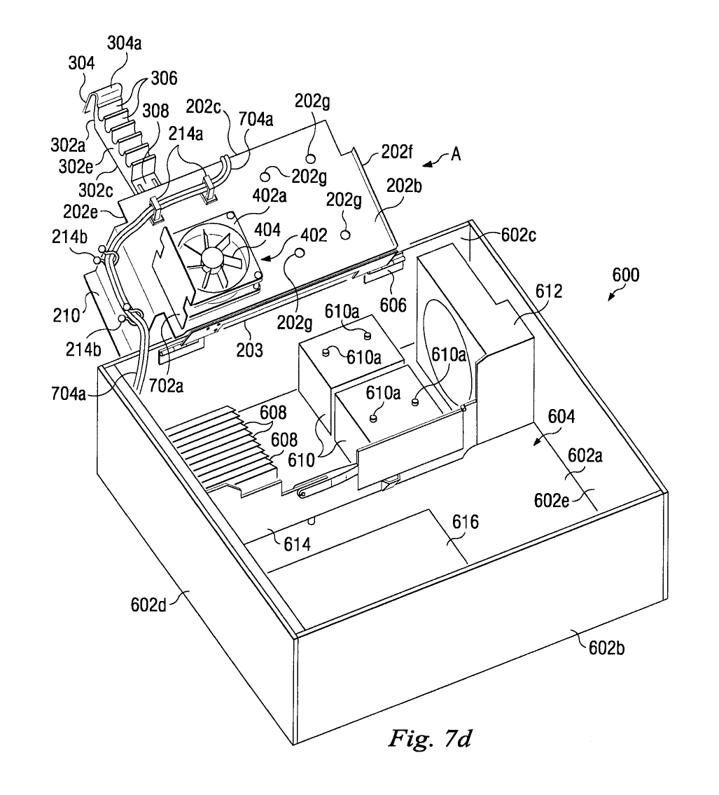

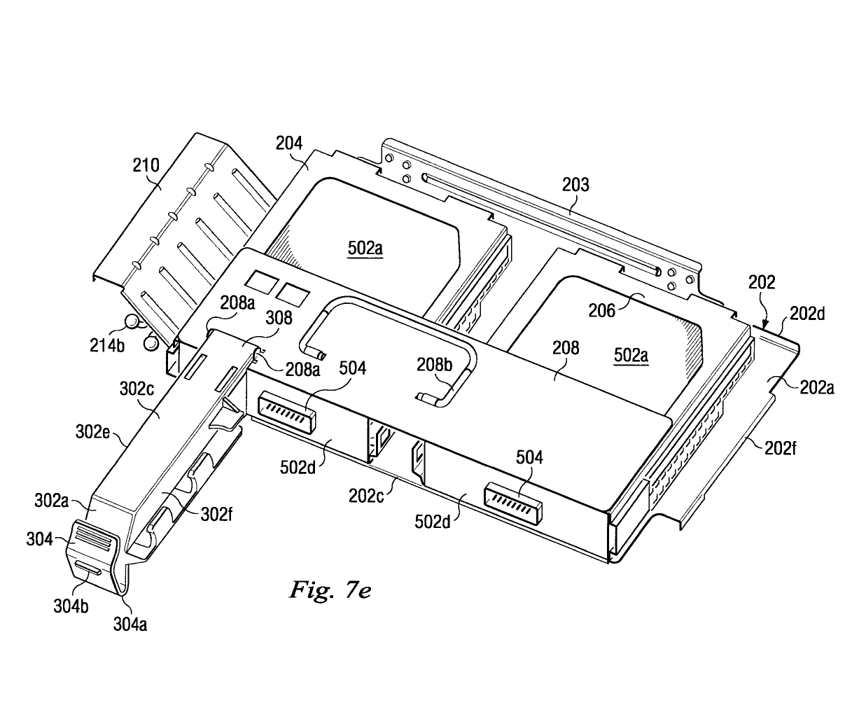

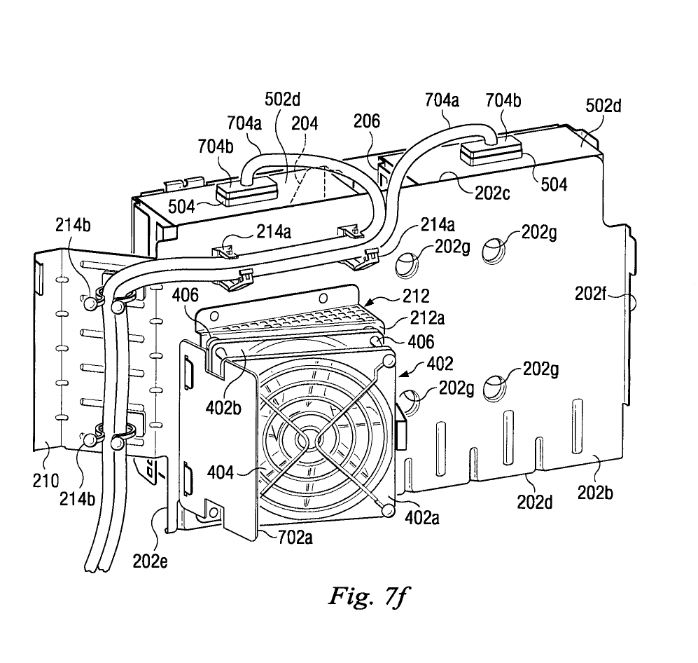

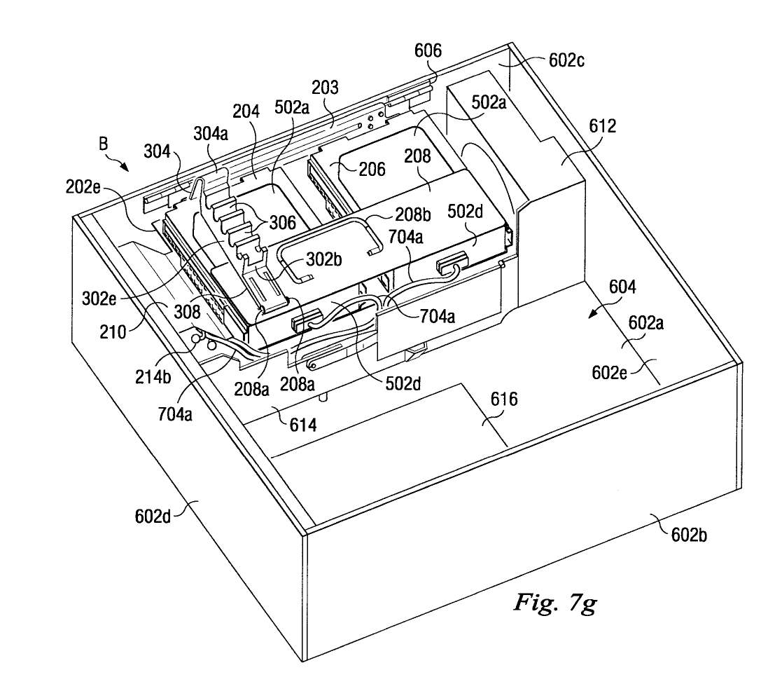

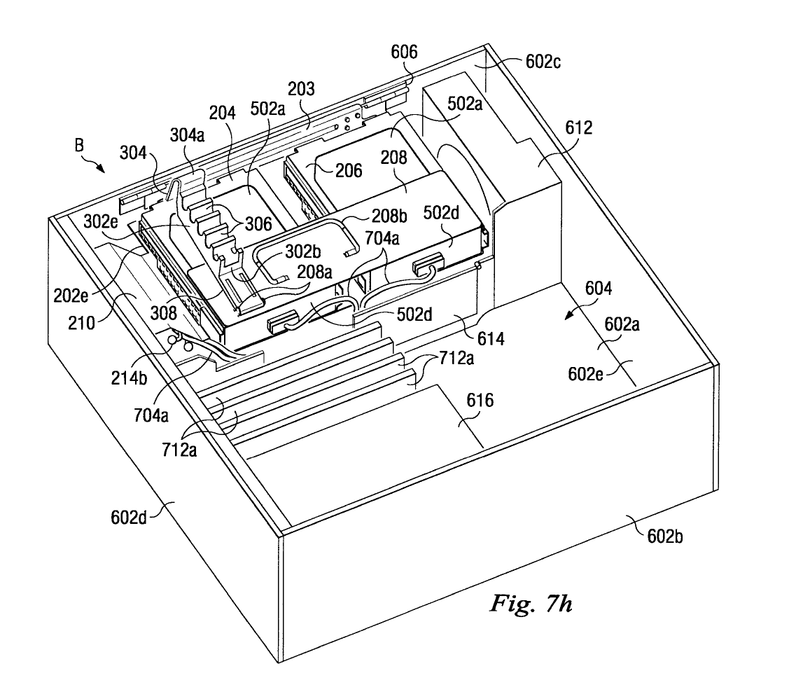

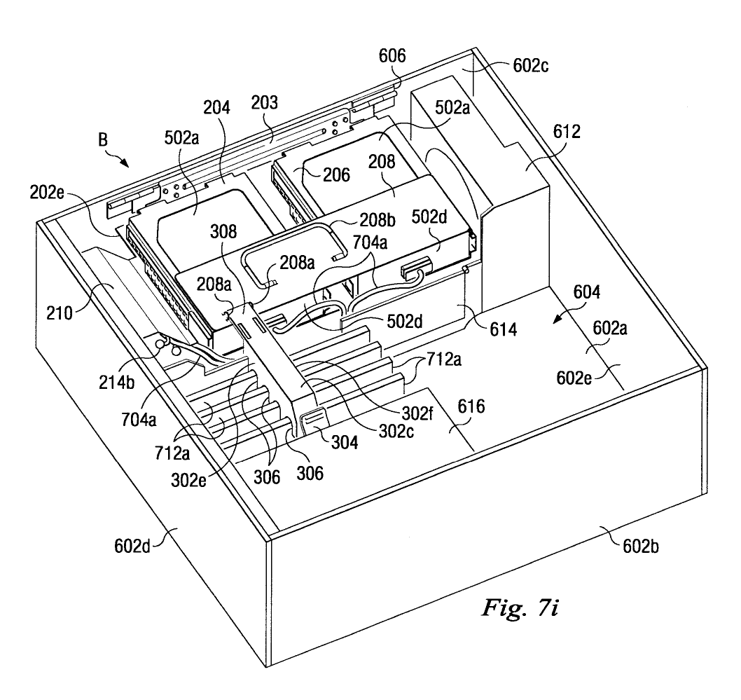

Referring now to FIGS. 6, 7a, 7b, 7c and 7d, a method 700 for coupling a modular component to a chassis is illustrated. The method 700 begins at step 702 where the chassis 600 is provided with the modular component mounting member 200. The card retention member 300 is pivotally coupled to the modular component mounting member 200 by coupling the pivotal coupling member 308 on the car retention member 300 to the pivotal coupling feature 208a on the modular component mounting member 200 using methods known in the art, as illustrated in FIG. 7b. The fan module 400 is coupled to the modular component mounting member 200 by engaging the couplers 406 extending from the rear surface 402b of the fan module 400 with the fan mounting apertures 212b defined by the fan mount 212, as illustrated in FIG. 7c. With the fan module 400 coupled to the fan mount 212, the fan 404 is oriented at an angle with respect to the bottom surface 202b of the modular component mounting member 200. In an embodiment, a baffle 702a may be coupled to the bottom surface 202b of the modular component mounting member 200 adjacent the fan module 400 in order to direct air from the fan 404. The modular component mounting member 200 is coupled to the chassis 600 by coupling the pivotal coupling member 203 extending from the rear edge 202d of the modular component mounting member 200 to the pivotal coupling 606 located on the rear wall 602c of the chassis 600 such as, for example, by engaging fasteners with the pivotal coupling member 203 and the coupling apertures 606a defined by the pivotal coupling 606, as illustrated in FIG. 7d. With the modular component mounting member 200 pivotally coupled to the chassis 600, the modular component mounting member 200 may be oriented in an access position A that is outside of the chassis housing 604, as illustrated in FIG. 7d.

Referring now to FIGS. 7a, 7d, 7e, and 7f, the method 700 proceeds to steps 704 and 706 where cables are routed on the modular component mounting member 200 and a modular component is coupled to the modular component mounting member 200. Cables 704a including connectors 704b that may be, for example, coupled to a board that is located on the chassis floor 602a or coupled to a component of the IHS that is located in the chassis housing 604, are routed on the modular component mounting member 200 by engaging the cables 704a with the cable routing members 214a and 214b extending from the bottom surface 202b of the modular component mounting member 200 and the baffle member 210, as illustrated in FIGS. 7d and 7f. With the cables 704a routed on the modular component mounting member 200, the cables 704a are moved out of the way of the chassis housing 604 when the modular component mounting member 200 is in the access position A, which allows unimpeded access to the components located in the chassis housing 604 such as the heat producing devices 608 and/or the heat sinks 610. A pair of the modular components 500 are coupled to the modular component mounting member 200 by positioning the modular components 500 in the modular component housings 204a and 206a defined by the modular component housing members 204 and 206, respectively, such that the IHS connectors 504 are located adjacent the front edge 202c of the modular component mounting member 200, as illustrated in FIG. 7e. The connectors 704b on the cables 704a are then coupled to the IHS connectors 504 on the modular components 500, as illustrated in FIG. 7f.

Referring now to FIGS. 7a, 7d and 7g, the method 700 proceeds to steps 708 and 710 where the modular component mounting member 200 is pivoted into the chassis housing 604 and the heat sinks 610 in the chassis housing 604 are supported. The modular component mounting member 200 is pivoted about the coupling of the pivotal coupling member 203 extending from the rear edge 202d of the modular component mounting member 200 and the pivotal coupling 606 located on the rear wall 602c of the chassis 600 from the access position A, illustrated in FIG. 7d, to a closed position B where the modular component mounting member 200 is located within the chassis housing 604, as illustrated in FIG. 7g. In an embodiment. The modular component mounting member 200 may be pivoted, for example, using the handle 208b. Furthermore, as the modular component mounting member 200 pivots into the closed position B, the heat sink support members 610a become positioned in the heat sink support features 202g, which provides support for the heat sinks 610 during, for example, shock and vibration events.

Referring now to FIGS. 7a, 7d, 7h and 7i, the method 700 proceeds to steps 712 and 714 where cards are retained in the chassis housing 604 and the heat producing devices 608 are cooled. A plurality of cards 712a are coupled to the chassis 600 on the chassis floor 602a and located in the chassis housing 604 between the support member 616 and the baffle 614, as illustrated in FIG. 7h. The card retention member 300 is then pivoted about the pivotal coupling of the pivotal coupling member 308 on the card retention member 300 and the pivotal coupling feature 208a on the modular component mounting member 200 until the card retention member 300 engages the cards 712a such that the cards 712a are located in the card engagement channels 306, as illustrated in FIG. 7i. With the card retention member 300 pivoted as show in FIG. 7i such that the cards 712a are located in the card engagement channels 306, the securing member 304b on the card retention member 300 engages the support member 616 in the chassis 600 to secure the card retention member 300 in the position shown in FIG. 7i such that the cards 712a are retained in the chassis housing 604. The fan module 400 may then be activated such that the fan 404 directs air towards the heat producing devices 608 in order to cool the heat producing devices 608. Furthermore, the base 202 of the modular component mounting member 200 acts as a baffle to direct air from the fan 612 between the modular components 500 and the components of the IHS in the chassis 600 such as, for example, the heat sinks 610, processors, memory 608, and a variety of other components known in the art. Thus, a method and apparatus are provided that provide a mounting location for modular components in a crowded chassis that addressees the cooling of heat producing devices, the support of heat sinks, the retention of cards, while not compromising the serviceability of the IHS.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A modular component coupling apparatus, comprising:
a chassis defining a chassis housing; and
a modular component mounting member pivotally coupled to the chassis, wherein the modular component mounting member defines a modular component housing, whereby the modular component mounting member is operable to pivot relative to the chassis between a first position that is outside of the chassis housing and a second position that is within the chassis housing.

2. The apparatus of claim 1, further comprising:
a fan mounted to the modular component mounting member.

3. The apparatus of claim 1, further comprising:
a card retention member pivotally coupled to the modular component mounting member.

4. The apparatus of claim 1, further comprising:
a plurality of cable routing members extending from the modular component mounting member.

5. The apparatus of claim 1, further comprising:
a handle located on the modular component mounting member.

6. The apparatus of claim 1, wherein the modular component mounting member defines a plurality of modular component housings.

7. The apparatus of claim 1, wherein the pivotal coupling of the modular component mounting member and the chassis comprises a friction hinge.

8. The apparatus of claim 1, wherein the modular component mounting member comprises a heat sink support feature.

9. The apparatus of claim 1, wherein with the modular component mounting member in the second position, the modular component mounting member is operable to direct air at a first component located in the modular component housing and at a second component located adjacent the modular component mounting member and in the chassis housing.

10. An information handling system (IHS), comprising:
an IHS chassis defining an IHS housing;
a board mounted to the IHS chassis and located in the IHS housing;
a processor coupled to the board;
a modular component mounting member pivotally coupled to the IHS chassis, wherein the modular component mounting member defines a modular component housing, whereby the modular component mounting member is operable to pivot relative to the IHS chassis between a first position outside of the IHS housing and a second position within the IHS housing; and
a modular component located in the modular component housing and electrically coupled to the processor.

11. The system of claim 10, further comprising:
a fan mounted to the modular component mounting member; and
a heat producing device coupled to the board and located in the IHS housing, whereby the fan is operable to cool the heat producing device when the modular component mounting member is in the second position.

12. The system of claim 10, further comprising:
a card retention member pivotally coupled to the modular component mounting member; and
a card coupled to the board and located in the IHS housing, whereby the card retention member is operable to pivot into engagement with the card when the modular component mounting member is in the second position.

13. The system of claim 10, further comprising:
a plurality of cable routing members extending from the modular component mounting member; and
a cable electrically coupling the modular component to the processor and coupled to the cable routing members on the modular component mounting member.

14. The system of claim 10, further comprising:
a handle located on the modular component mounting member.

15. The system of claim 10, wherein the modular component mounting member defines a plurality of modular component housings, whereby a plurality of modular components are located in respective modular component housings and electrically coupled to the processor.

16. The system of claim 10, wherein the pivotal coupling of the modular component mounting member and the chassis comprises a friction hinge.

17. The system of claim 10, further comprising:
a heat sink coupled to the processor, wherein the modular component mounting member comprises a heat sink support feature that engages the heat sink when the modular component mounting member is in the second position.

18. The system of claim 10, wherein with the modular component mounting member in the second position, the modular component mounting member is operable to direct air at the modular component and at the processor.

19. A method for coupling a modular component to a chassis, comprising:
providing a chassis that defines an IHS housing and comprises a modular component mounting member defining a modular component housing and pivotally coupled to the chassis;
coupling a modular component to the chassis by positioning the modular component in the modular component housing; and
pivoting the modular component mounting member from a first position that is outside the IHS housing to a second position that is within the IHS housing.

20. The method of claim 19, further comprising:
cooling a heat producing device located in the IHS housing when the module component is in the second position with a fan that is mounted to the modular component mounting member.

21. The method of claim 19, further comprising:
retaining a card that is located in the IHS housing when the module component mounting member is in the second position by pivoting a card retention device that is pivotally coupled to the modular component mounting member into engagement with the card.

22. The method of claim 19, further comprising:
routing a cable coupled to the modular component through a plurality of cable routing members extending from the modular component mounting member.

23. The method of claim 19, further comprising:
supporting a heat sink that is located in the IHS housing when the modular component mounting member is in the second position with a heat sink support feature that is located on the modular component mounting member.

24. The method of claim 19, further comprising:
directing air with the modular component mounting member between the modular component and an information handling system component located in the IHS housing.
